(19) United States
(12) Patent Application Publication
(10) Pub. No.: US 2017/0277164 A1
(43) Pub. Date: Sep. 28, 2017

(54) Computer implemented method for dissimilarity computation between two yarns to be used for setting of a textile machine in a textile process, and computer program product

(71) Applicant: UNIVERSITAT POLITÈCNICA DE CATALUNYA, Barcelona (ES)

(72) Inventors: Miquel SÀNCHEZ MARRÈ, Barcelona (ES); Beatriz SEVILLA VILLANUEVA, Barcelona (ES); Thomas, V. FISCHER, Barcelona (ES)

(21) Appl. No.: 15/500,223

(22) PCT Filed: Jul. 31, 2015
(86) PCT No.: PCT/IB2015/001292

§ 371 Date: Jan. 30, 2017

(30) Foreign Application Priority Data
Jul. 31, 2014 (EP) 14179279.6

(51) Int. Cl. G05B 19/406

(52) U.S. Cl. CPC G05B 19/406; G05B 2219/45196

(57) ABSTRACT

The setting of textile machinery parameters is an important aspect that combines implicit knowledge of workers and engineers with explicit knowledge. As yarn and fabrics involved in a textile process are multicomponent artefacts, in order to automatize this process of machine configuration, a method for dissimilarity computation between two yarns is proposed including one or a combination of four algorithms to evaluate the similarity between two yarns, each composed by a list of materials. The method has proved to be successful for spinning setting and it can be applied in other steps of a textile process like weaving.

### TECHNICAL FIELD

The invention relates to the textile industry. The method of the invention is used for predicting different configuration parameters or machine settings of several textile machines involved in the manufacture of textiles such a spinning machine to produce a new yarn or a weaving machine to produce a new fabric article which is one of the main problems for reducing the costs of the production in this field.

A yarn used in a textile process will be here identified by physical properties including at least count and by a list of materials (or components) each material in turn being defined by percentage of presence, belonging to a family of materials and by some physical material properties including fineness and length.

### BACKGROUND OF THE INVENTION

Textile manufacturing is a complex and a distributed process. This complexity depends on the processes that are involved and on the complexity of the textile product. The most common sub-processes integrated into the production are spinning, weaving, knitting, non-woven and finishing.

At present textile manufacturing tends to produce more complex textile products such as technical or medical textiles needing of special yarns. But also the production of textiles for fashion and clothing is facing challenges, as a lot of raw materials are natural products such as cotton, silk, and wool. These raw materials vary slightly in terms of physical properties, e.g. elongation or resistance. The variation may be small, but optimal process settings are sensitive to such changes.

Currently the production of a new textile product requires a high cost in terms of time, effort and money. Thus, one of the main objectives of the global textile industry is the reduction of this high cost of production of new textiles. To do this, many companies are investing to include technological tools that can help in achieving this goal. For instance, spinning companies are focusing on recycled materials and therefore, they have more than 300 materials to consider for the production of a yarn.

In a factory about 50% of orders usually refer to existing products or to products which are very similar. Therefore, the remaining 50% require a new configuration of the parameters of the machines involved in the process. This leads to adjust 100 or more parameters for each machine involved in the manufacturing process. Therefore, the incidence of reconfiguration of several textile machines is a problem of considerable volume.

As in other fields the textile industries tend to work on demand with small amounts of products (small lot size). This implies a constant variation of textile products to be manufactured, and thus the need of a continuous reconfiguration of the parameters of the different machines in the manufacturing process, further increasing the production costs and the response times to orders. The most common practice is to produce small samples of textile from which the parameters are adjusted until a desired product with all the requested features is obtained through a process of trial and error based on existing standard settings. Therefore, this process, as mentioned, is very expensive and slow, resulting in loss of money and time on the part of the textile industries.

All textile machines have a user manual that explains each of the parameters that can be set on the machine. However, the setting of the parameters is done by trial and error, since the values defined in the manual do not match the real requirements either by the type of material used (with different compositions) or due to any other external factor such as the thermal conditions. Furthermore, it is not possible to define all the characteristics and parameters of a textile structure because of the difficulty of measuring them. This makes very difficult to set up the machines involved in the manufacture of textiles.

For this reason, the setting of parameters is done on the basis of expert knowledge, i.e. setting is made by experts, considering past experiences and knowledge of the similarity between two products, which depends largely on the similarity of the yarns that form them, since similar products require a similar setting of the machine parameters. This expertise has been generated over time long processes of trial and error. In addition the knowledge in the textile industry is documented only partially.

This configuration process can be simulated computationally using an Intelligent Decision Support System (IDSS) based on Case-Based Reasoning. This system needs to define how similar are two processes. Because the configuration, by the experts, is limited to their own experience and memory, an automated system can take into account much more information and therefore be very valuable in this sector.

The degree of similarity of two textile processes depends on the similarity of the different parts of the process including the textile products and thus, on the comparison of the material that compose these products. In spinning, the end products are yarns and the raw material are fibres and in the rest of processes the yarns are the raw material. The calculation of the degree of similarity between two yarns is extremely difficult as the yarns can be composed of different fibre types (different material type) with different percentages of presence. In addition, the calculation of the similarity of two yarns is influenced by other properties such as thickness, twist, target sector, etc. The latter properties can be modelled by numerical or categorical values and their respective degrees of similarity can be easily calculated. It could be easy to compare two yarns composed of the 100% same cotton type. In reality the yarns are composed of many different fibres, for example, a yarn composed of 80% regenerated cotton and 20% viscose has to be compared with a yarn composed of a 40% cotton, 20% polyester, 20% wool and 20% elastane.

Advanced systems in the textile industry are able to simulate a textile product, but they are usually limited to deliver a visual representation of the product without providing an assessment of the mechanical or physical structure of the textile product allowing to be compared to determine the degree of similarity between two yarns, and therefore do not provide a help for configuring the textile machine settings.

In literature, there are works dealing with the evaluation of the similarity of one of the characteristics of the yarns, but always considering yarns having a same composition (materials and percentage).

Cheng, Y., Cheng, K.: “Case-based reasoning system for predicting yarn tenacity”. Textile Research Journal 74, 718-722 (2005) discloses an approach dealing with yarns of the same composition and some different physical characteristics that can be numerically modelled, such as tenacity.

Sette, S., Boullart, L., Van Langenhove, L., Kiekens, P.: “Optimizing the fiber-to-yarn production process with a combined neural network/genetic algorithm approach, Textile Research Journal, 67(2), 84-92 (1997) discloses optimizing the process of spinning to get a quality product, however, the input data are numerical and are based on easily measurable physical characteristics, but regardless of the composition of the materials.

In Beatriz Sevilla Villanueva and Miguel Sanchez Marré in “Case-based reasoning applied to textile industry processes”, Springer Berlin Heidelberg 428-442 (2012), a previous work of some of the present inventors, CBR has been applied to the textile industry in order to optimize the configuration of textile structures performing a mathematical analytical simulation on the mechanism that actuate on the internal materials of these textiles structures. In that work, the case base is automatically built for each case with processes where the yarns have the same composition and only physical properties were taken into account.

The present inventors are not aware of any previous works that address the complexity of the yarn composition allowing configuring machine parameters of a textile machine in the following situations:
New products (new combination of materials) for a customer request.
Existing products with one material substituted by a similar one due to limited availability of raw materials in storage.
Change of settings during production due to low efficiency or quality of the produced textile product.

### DISCLOSURE OF THE INVENTION

In this invention, in a first aspect, a computer implemented method is proposed providing comparison and evaluation of the degree of the similarity between two yarns to be used for setting of a textile machine in a textile process manufacturing a textile product wherein in the textile process a first yarn is used and said setting involving the use of a second yarn selected from several candidate yarns, both said first and second yarns being identified by physical properties including at least count and by a composition including a list of materials, each material in turn being defined by percentage of presence, belonging to a family of materials and by some physical properties including fineness and length.

The method according to this invention comprises following steps (performed in any order):
a) automatically computing material dissimilarity values of all possible combination of the materials of said list of materials of the first and second yarns (specific examples are provided later); and
b) automatically calculating a dissimilarity value between the first and second yarns under comparison by applying an algorithm using as inputs the list of materials of the first and second yarns and said computed material dissimilarity values,
   wherein said applying of said algorithm including a weighted aggregation using said material dissimilarity values computed of different combination of pairs of materials of said first and second yarns to be compared, where the weights depend on the presence and/or percentage of these materials in the yarns.

In general said first and second yarns for each comparison are different in that having a different percentage of the same materials and/or in that they include a list of different materials and/or having a different value for some material properties (fineness, length, etc.).

In order to perform referred computing of material dissimilarity values a textile expert knowledge is used (see for Example the Table of FIG. 1) that provides dissimilarity between each pair of materials and that further provides an optimal range of length and optimal range of fineness between each pair of materials.

To achieve the calculation of the dissimilarity value among two yarns taking into account the list of materials of both yarns under comparison one of the following four algorithms (A1 to A4) is proposed

### Algorithm A1

This algorithm performs comparisons among pairs of materials of said first and second yarns with an equivalent percentage and proceeds iteratively selecting the combinations of the pairs to be compared having a lower dissimilarity value being the corresponding weight of each pair of materials the smallest percentage in common and then comparing among them the rest of materials, obtaining several material dissimilarity values and then performing a weighted aggregation of said dissimilarity values.

The selection of the pairs of materials to be compared depends on how similar they are, so those pairs of materials having a lower dissimilarity are selected and the weight is the smallest percentage of the two materials. That is, for example, with a first yarn of 60% cotton and 40% wool and a second yarn of 80% viscose and 20% cotton, first cotton of both yarns is compared and weighted by 20%, then the remaining 40% cotton,40% wool and 80% viscose is compared the remaining pairs being chosen with lower dissimilarity between (cotton, viscose) and (wool, viscose).

### Algorithm A2

This second algorithm is a variant of the first in which the main material (higher presence) is taken into account. The algorithm performs comparisons among pairs of materials of said first and second yarns taking into account the main material with an equivalent percentage and then proceeds iteratively selecting the combinations of the pairs to be compared having a lower dissimilarity value being the corresponding weight of each pair of materials the smallest percentage and then comparing among them the rest of materials, obtaining several material dissimilarity values and then performing a weighted aggregation of said dissimilarity values.

Thus in this algorithm, first, the materials with higher presence (main) and their common percentage to weight are used, i.e. if there is a yarn with 60% cotton and other with 80% viscose, cotton and viscose are selected and weighted with 60%. Then, pairs of components with higher similarity are selected and the common percentage is used in the same way as in the first algorithm.

### Algorithm A3

In this algorithm at first a common part from both first and second yarns is disregarded. The common part is defined as the set of pairs of materials with the same percentage and dissimilarity equal to 0. If the percentages are not equal, then only the lower percentage is disregarded and then all the possible combinations among the pairs of the list of the remaining materials of both yarns are compared (i.e. the remaining materials are all compared against all) obtaining several material dissimilarity values and then a weighted aggregation of the material dissimilarity values is performed wherein the weight of each pair of materials is the product of both material percentages divided by the percentage of the remaining uncommon part.

So being Y₁′ and Y₂′ the remaining materials of the yarns Y₁ and Y₂ after disregarding the common part respectively, the algorithm is defined by the following formula:

$$CrossAlg ( {Y}_{1}^{′} , {Y}_{2}^{′} ) = {\sum }_{i = 1}^{N} {\sum }_{j = 1}^{M} \frac{{PERC}_{i} ( {Y}_{1}^{′} ) * {PERC}_{j} ( {Y}_{2}^{′} )}{remain percentage} * {Dissim}_{MAT} ( {MAT}_{i} ( {Y}_{1} ) , {MAT}_{j} ( {Y}_{2} ) ) ,$$

wherein N is the number of remaining materials from yarn 1, M is the number of remaining materials of the yarn 2, PERCᵢ(Y₁′) is the percentage of the material i of Y₁′, PERCⱼ(Y₂′) is the percentage of the material j of Y₂′, remain percentage is 1—common percentage. Dissim_{MAT} (MATᵢ(Y₁), MATⱼ(Y₂)) is the dissimilarity of the materials i and j from yarns 1 and 2 respectively.

### Algorithm A4

This algorithm performs an iterative comparison selecting the possible combinations among the list of pairs of materials of said first and second yarns by percentage operating by decreasing order of percentage obtaining several material dissimilarity values and then performing a weighted aggregation of said dissimilarity values, and in case the number of materials in a list being not the same, each material in a list without pair a maximum dissimilarity value equal to 1 (in case that all dissimilarities are scaled in 0 to 1) is added to said aggregation, wherein each material dissimilarity weight is computed as the mean value of both percentages of each pair of materials.

So, for each yarn their materials are ordered by their percentage from higher to lower and then, the first is compared with the first, the second with the second and so on. In case the number of materials being not the same, the material without pair is added with a maximum distance value. Given a yarn Y₁ with equal or more materials than yarn Y₂, the algorithm is defined by the following formula:

$$Alg A 4 ( {Y}_{1} , {Y}_{2} ) = {\sum }_{i = 0}^{M} mean ( PERC ( {MAT}_{i} ( {Y}_{1} ) ) , PERC ( {MAT}_{i} ( {Y}_{2} ) ) ) * {Dissim}_{MAT} ( ( {MAT}_{i} ( {Y}_{1} ) , ( {MAT}_{i} ( {Y}_{2} ) ) + {\sum }_{i = M + 1}^{N} \frac{PERC ( {MAT}_{i} ( {Y}_{1} ) )}{2} * {Dis}_{MAX} \qquad ( 1 )$$

where M is the number of materials of Y2, N is the number of materials of Y1 and N≧M.

As previously indicated the algorithm for the calculation of the dissimilarity value among two yarns taking into account the list of materials of both yarns can be an average or a combination of two or more of the referred algorithms A1 to A4.

Therefore a result useful for setting of a textile machine using least second yarn is computed from a weighted aggregation of a dissimilarity value obtained from a method according to any of the referred algorithms (A1 to A4) and other dissimilarities values regarding physical properties of said at least second yarn including count, sector and other properties of the involved yarns obtained from a textile expert knowledge. This appears reflected in the block diagram of FIG. 3, right side, where the Dissimilarity of Yarn 1 and Yarn 2 is obtained from a weighted aggregation of a dissimilarity value obtained from any of the A1 to A4 algorithms or a combination of two or more of them and other dissimilarities values obtained in general from textile expert knowledge.

In a second aspect, a computer program product intended to implement above method, either basic steps or specific algorithm/s is also provided.

### BRIEF DESCRIPTION OF THE DRAWINGS

FIG. 1 is a reduced Distance Material Family table, obtained from technical expert gathered information, scaled in [0,1].

FIG. 2 is a diagram showing the hierarchy of the material families and subtypes of the fibres of a yarn.

FIG. 3 is a block diagram showing the components and steps of the method according to this invention.

### DETAILED DESCRIPTION OF EXEMPLARY EMBODIMENTS

Two yarns of different composition can have similar behaviour from the textile point of view and, therefore, one may be a substitute for the other and the textile machinery settings can be reused.

Given two yarns, their physical properties and the composition of their fibres are compared. The physical characteristics of the yarn that are measurable can be compared using their numeric value with existing distance metrics such as the Euclidean. Typically, these characteristics refer to different physical aspects of the yarn such as thickness, torsion, elongation or resistance. These characteristics depend on how the yarn is produced and the materials it is composed of. Other features like the sector are qualitatively modelled because they cannot be modelled numerically and what is only known is if they are equal or different. The composition of the yarn is a combination of different fibre types with a percentage of presence.

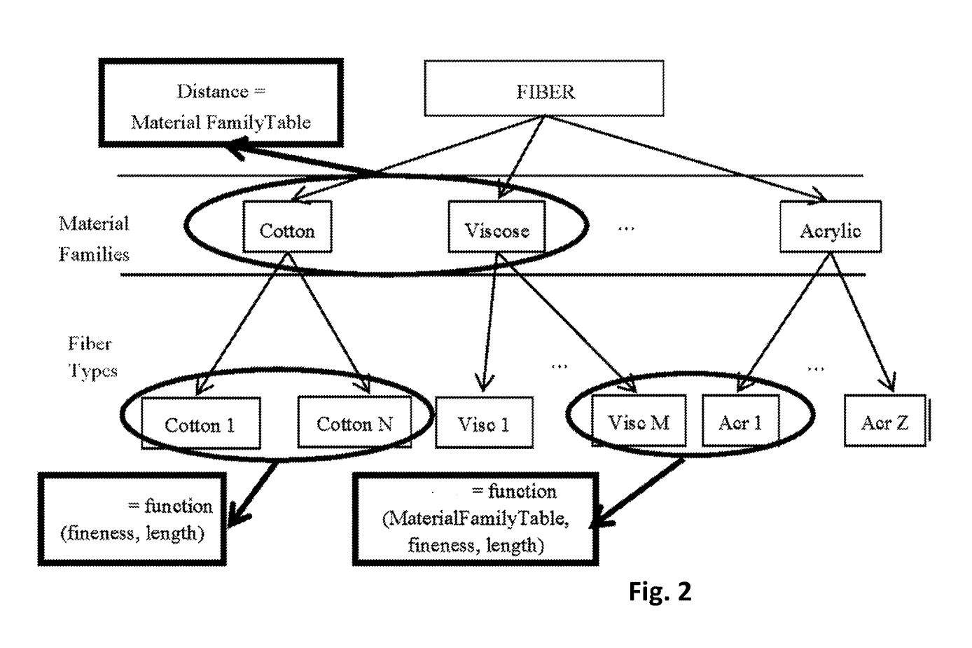

Fibres can be classified into different families depending on the material that are composed: cotton, viscose, silk, wool, etc. At the same time, each family has different types of fibres. The differences between fibre types from the same family are based on certain physical characteristics of the fibres such as the length and/or fineness. However, in general, materials from the same family with different physical characteristics are more similar than those from different families with but similar physical characteristics according to the experts' knowledge. In FIG. 2 of the drawings, a hierarchy of the families and subtypes of the fibres is shown.

Therefore, given two yarns, its composition and the physical characteristics of their fibres, a computer implemented method is proposed to calculate how similar these two yarns are. The complexity of this procedure lies in comparing different compositions since both the number of materials and their percentage are variable.

A yarn can be understood as a list (LM (Hᵢ)) of different materials (components) or fibres and each material (MATᵢ(Hⱼ)) has a certain percentage of presence (PERCᵢ(Hⱼ)). A material can be a composition itself (yarn) or be composed of fibres of the same type (material). Usually, the main material (higher presence) defines the behaviour of the yarn and is therefore more important than the other materials.

The different types of fibres or materials are classified into different families of materials belonging to the (MATFAMᵢ(Hⱼ). And the materials/fibres of the same family are differentiated by certain characteristics or physical properties. Typically these include the diameter (FINENESSᵢ (Hⱼ)) and length (LENGTHᵢ(Hⱼ)). Therefore, the composition of a yarn can be generalized to a list of materials (LM) where each material MATⱼ has: a percentage of presence, PERCⱼ, a material family MATFAMⱼ and some physical characteristics of the fibres which describe fibres that make up this particular material.

The different fibre types are classified into different material families (see FIG. 2). The specificity of theses materials would depend on the needs of the end user where the method is applied. Fibre types of the same family can have different physical characteristics. Typically these characteristics include the fineness FINENESSⱼ and length LENGTHⱼ of the fibres.

Given two yarns (H₁, H₂) the degree of dissimilarity among them is calculated taking into account:
The characteristics of the yarn:
   Physical properties: count, etc.
   Other properties: sector, etc.
The composition (materials, percentage and material properties)
   and a criteria of how to compare the different materials (by pairs) and its percentages

The yarns H₁, H₂ can be modelled as follows:

H₂=<PHYSICAL PROPERTIES (H₁), OTHER PROPERTIES (H₁), LM (H₁)>
PHYSICAL PROPERTIES (H₁)=<COUNT (H₁), PROP₂ (H₁), . . . , PROP_{L} (H₁)>
OTHER PROPERTIES (H₁)=<SECTOR (H₁), OT.PROP₂(H₁), . . . , OT.PROP_{T} (H₁)>
LM (H₁)=<MAT₁(H₁), . . . , MAT_{N} (H₁)>
MATᵢ(H1)=<PERCᵢ(H₁), MATFAMᵢ(H₁), MATERIAL PROPERTIES(H₁)>
MATERIAL PROPERTIES (H₁)=<FINENESSᵢ(H₁), LENGTHᵢ(H₁), . . . ,M.PROPₖ(H₁)>
H₂=<PHYSICAL PROPERTIES (H₂), OTHER PROPERTIES (H₂), LM (H₂)>
PHYSICAL PROPERTIES (H₂)=<COUNT (H₂), PROP₂(H₂), . . . ,PROP_{L}(H₂)>
OTHER PROPERTIES (H₂)=<SECTOR (H₂), OT.PROP₂ (H₂), . . . , OT.PROP_{T}(H₂)>
LM (H₂)=<MAT₁(H₂), . . . , MAT_{M} (H₂)>
MATᵢ(H₂)=<PERCᵢ(H₂), MATFAMᵢ(H₂), MATERIAL PROPERTIES(H₂)>
MATERIAL PROPERTIES (H₂)=<FINENESSᵢ(H₂), LENGTHᵢ(H₂), . . . , M.PROPₖ(H₂)>

COUNT (Hᵢ) (in Nm) is the number of meters of yarn per kg (smaller values indicate higher yarn diameter) and it can be numerically modelled and SECTOR (Hi) is a qualitative label that designates the area of production and it can be qualitatively modelled.

Count is an important property of the description of a yarn, but there are also other important physical properties that can be taken into account if necessary such as the tenacity and yarn twist. Likewise, there are other properties that may be important for the description of the yarn and that can vary depending on the application of the yarn and in this case the sector has been highlighted.

### Calculation of the Dissimilarity Between Two Yarns

The dissimilarity between two yarns is defined as a weighted sum of the dissimilarity of their features:

$$Dissim ( {H}_{1} , {H}_{2} ) = {W}_{COUNT} * {Dissim}_{COUNT} ( {H}_{1} , {H}_{2} ) + {\sum }_{i = 2}^{L} {W}_{i} * {Dissim}_{{PROP}_{i}} ( {H}_{1} , {H}_{2} ) + {W}_{SECTOR} * {Dissim}_{SECTOR} ( {H}_{1} , {H}_{2} ) + {\sum }_{i = 2}^{T} {W}_{i} * {Dissim}_{OT \cdot {PROP}_{i}} ( {H}_{1} , {H}_{2} ) + {W}_{LM} * {Disim}_{L M} ( {H}_{1} , {H}_{2} )$$

wherein ΣWᵢ=W_{COUNT}+Σᵢ₌₂^{L}Wᵢ+W_{SECTOR}+Σᵢ₌₂^{T}Wᵢ+W_{LM}=1 and all the dissimilarities are comprised between 0 and 1.

I.e. a weighted sum where one term is the composition (list of materials) and the rest can be physical properties (e.g. count) or other properties (e.g. sector).

In this case only taking into account the COUNT, and SECTOR the formula would be:

Dissim(H₁,H₂)=W_{COUNT}*Dissim_{COUNT}(H₁,H₂)+W_{SECTOR}*Dissim_{SECTOR}(H₁,H₂)+W_{LM}*Dissim_{LM}(H₁,H₂)

wherein ΣWᵢ=W_{COUNT}+W_{SECTOR}+W_{LM}=1

and

Dissim(H₁,H₂)∈[0,1],Dissim_{COUNT}(H₁,H₂)∈[0,1],Dissim_{SECTOR}(H₁,H₂)∈[0,1],Dissim_{LM}(H₁,H₂)∈[0,1]

### Calculation of Dissimilarity According to the COUNT Attribute.

According to the expert opinion, the dissimilarity between two small values is higher than among larger values. Thus, the dissimilarity does not follow a linear growth and, therefore, a relative measure that takes into account this effect is proposed to be used:

$${Dissim}_{COUNT} ( {H}_{1} , {H}_{2} ) = \frac{/ COUNT ( {H}_{1} ) - COUNT ( {H}_{2} ) /}{max ( COUNT ( {H}_{1} ) , COUNT ( {H}_{2} ) )}$$

### Calculation of Dissimilarity According to the SECTOR Attribute.

SECTOR is a qualitative feature since it cannot be measured numerically. Therefore, whether both yarns belong to the same sector or not only can be assessed according to the following formula:

$${Dissim}_{SECTOR} ( {H}_{1} , {H}_{2} ) = \{ \begin{matrix}0 & si SECTOR ( {H}_{1} ) = SECTOR ( {H}_{2} ) \\ 1 & si SECTOR ( {H}_{1} ) \neq SECTOR ( {H}_{2} )\end{matrix}$$

### Calculation of Dissimilarity According to the List of Materials (LM)

For the composition of the yarn, the combination of four algorithms A1-A4 (that will be explained in detail in the following examples) is proposed. These algorithms are weighted sums of different combinations of pairs of materials, where the weights depend on the presence of these materials in the yarn. Each algorithm has a different strategy for choosing the pairs of materials to be compared and for calculation of its weights.

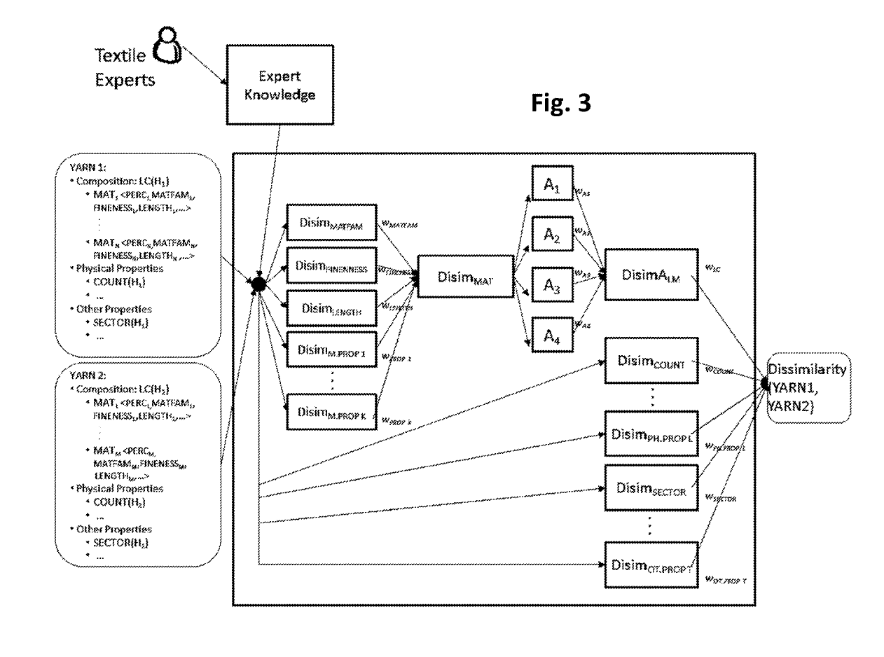

The dissimilarity between the two yarns may be the result of any of the presented algorithms or a combination of any of them (see FIG. 3), for example, the average of the four.

$${Dissim}_{LM} ( LM ( {H}_{1} ) , LM ( {H}_{2} ) ) = \frac{\begin{matrix}{A}_{1} ( LM ( {H}_{1} ) , LM ( {H}_{2} ) ) + {A}_{2} ( LM ( {H}_{1} ) , LM ( {H}_{2} ) ) + \\ {A}_{3} ( LM ( {H}_{1} ) , LM ( {H}_{2} ) ) + {A}_{4} ( LM ( {H}_{1} ) , LM ( {H}_{2} ) )\end{matrix}}{4}$$

$$wherein , \\ {A}_{1} ( LM ( {H}_{1} ) , LM ( {H}_{2} ) ) = MinAlg ( LM ( {H}_{1} ) , LM ( {H}_{2} ) )$$

$${A}_{2} ( LM ( {H}_{1} ) , LM ( {H}_{2} ) ) = MainMinAlg ( LM ( {H}_{1} ) , LM ( {H}_{2} ) )$$

$${A}_{3} ( LM ( {H}_{1} ) , LM ( {H}_{2} ) ) = CrossAlg ( LM ( {H}_{1} ) , LM ( {H}_{2} ) )$$

$${A}_{4} ( LM ( {H}_{1} ) , LM ( {H}_{2} ) ) = MainHigherAlg ( LM ( {H}_{1} ) , LM ( {H}_{2} ) )$$

### EXAMPLES

The “distance” term will be used in this section as equivalent to “dissimilarity” and component of a yarn would mean here a material thereof.

1. Example of Distance Between Two Yarns

Note: Count and Sector are avoided for this example.

1.1 Yarns to Compare:

Yarn 1: [0.6 PC (1.5, 38), 0.3 PL (3.3, 60), 0.1 CO−t1 (1.4,20)]

Yarn 2: [0.5 CO−t1 (1.4,20), 0.25 LI (1.6, 40), 0.15 W (8.85, 50), 0.1 CO−t2(1.5,22)]

That means that yarn 1 contains 3 components:
1. A component of type PC from the family of PC with a presence of 60% (0.6 of 1). The fibres of this component have a 1.5 of fineness and 38 of length.
2. A component of type PL from the family of PL with a presence of 30% (0.3 of 1). The fibres of this component have a 3.3 of fineness and 60 of length.
3. A component of type CO−t1 from the family of CO with a presence of 10% (0.1 of 1). The fibres of this component have a 1.4 of fineness and 20 of length.
Yarn 2 is represented in the same way.

The main components are PC and CO respectively.
1.2 Weight for the Weighted Aggregation:

For the Initialization of weights following values from technical expert knowledge have been estimated:

W_{MATFAM}=0.75

W_{FINENESS}=0.25*0.7=0.175

W_{LENGTH}=0.25*0.3=0.075

(*) This is just an example. From the experts we know that W_{FINENESS}>W_{LENGTH}

1.3 Distance for the Physical Properties of Components

For scaling purpose, we assume that fineness ∈[0,10] and length ∈[0, 50]. The distance of fineness is assessed for this example with Relative distance:

$$dist ( A , B ) = \frac{\vert A - B \vert}{max ( A , B )}$$

The length distance is assessed with a normalized absolute distance:

$$dist ( A , B ) = \frac{\vert A - B \vert}{{LENGTH}_{MAX} - {LENGTH}_{MIN}} = \frac{\vert A - B \vert}{50 - 0}$$

1.4 Interpretation of the Expert's Table:

CO

| | | |
|---|---|---|
| WO | 0.3 | 0.7 |
| | 5 | 7 |
| | 5 | 6 |

0.3=distance between WO and CO (scaled in [0,1])
0.7=similarity between WO and CO (scaled in [0,1]) (it is complementary and not used) 5 7=Range of ratios of fineness. The optimal fineness ratio between WO and CO

$$( {ratio}_{{fineness}_{real}} = \frac{{WO}_{fineness}}{{CO}_{fineness}} )$$

is in [5,7]. That means that the fineness of WO is in 5 to 7 times greater to the CO fineness to consider that the distance of WO and CO is 0.3. Otherwise the distance should be greater.

5 6=Range of ratios of length. The optimal length ratio between WO and CO

$$( {ratio}_{{length}_{real}} = \frac{{WO}_{length}}{{CO}_{length}} )$$

is in [5, 6]. That means that the length of WO is between 5 and 6 times greater to the CO length to consider that the distance of WO and CO is 0.3. Otherwise the distance should be greater.

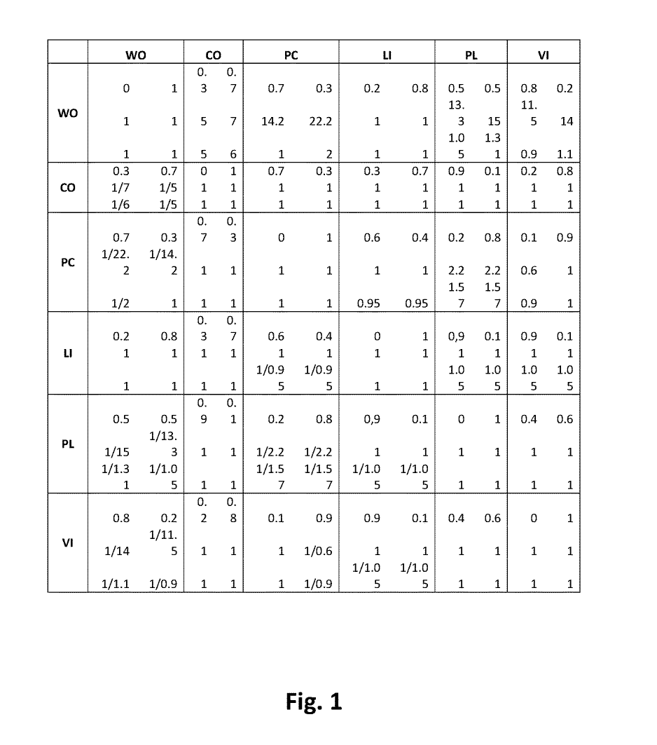

The reduced Distance Material Family table scaled in [0,1] is represented in FIG. 1

2. Assessment of the Distance of Two Yarns (Yarn 1, Yarn 2)

First all of possible combinations of components in both yarns are compared in order to save time in the four algorithms. Since all of them use a subset of these comparisons for this example, it is clearer to assess all before than to assess them when they are needed.

Then the four algorithms are assessed and finally, and for this example, the average of the four algorithms is calculated.

2.1 Distance Between Materials

Since of all the algorithms use the distance between two components. First, we compute these distances of all of possible combinations. Regarding that this distance involves material family, fineness and fibre length.

(*) Range of length=LENGTH_{MAX}−LENGTH_{MIN}=50−0=50
(**) If we have WO in Yarn 1 and CO in yarn 2, la distance_{MATFAM}=0,3. If

$${ratio}_{{fineness}_{real}} = \frac{{WO}_{fineness}}{{CO}_{fineness}}$$

is smaller than 5 then the expected_{fineness} of CO is assessed

$$( \frac{{WO}_{fineness}}{{ratio}_{{fineness}_{MIN}}} = \frac{{WO}_{fineness}}{5} )$$

of if is greater than 7,

$$( \frac{{WO}_{fineness}}{{ratio}_{{fineness}_{MAX}}} = \frac{{WO}_{fineness}}{7} ) .$$

This process is analogous to the length assessment.

$$distance ( PC , CO - t 1 ) = 0.56$$

$$1. distance ( PC , CO - t 1 ) = {w}_{M} * {distance}_{{material}_{family}} + {w}_{F} * {distance}_{fineness} + {w}_{L} * {distance}_{length}$$

$$2. {distance}_{{material}_{family}} = 0.7$$

$$3. {ratio}_{{fineness}_{real}} = \frac{1.5}{1.4} ∉ [ {ratio}_{{ideal}_{min}} = 1 , {ratio}_{{ideal}_{max}} = 1 ]$$

$$4. {expecte}_{fineness} = \frac{1.5}{1} = 1.5$$

$$5. {distance}_{fineness} = \frac{\vert 1.4 - 1.5 \vert}{max ( 1.4 , 1.5 )} = 0.067$$

$$6. {ratio}_{{length}_{real}} = \frac{38}{20} ∉ [ {ratio}_{{ideal}_{min}} = 1 , {ratio}_{{ideal}_{max}} = 1 ]$$

$$7. {expected}_{length} = \frac{38}{1} = 38$$

$$8. {distance}_{length} = \frac{\vert 20 - 38 \vert}{{max}_{length}} = 0.36$$

$$9. distance ( PC , CO - t 1 ) = 0.75 * 0.7 + 0.175 * 0.067 + 0.075 * 0.36 = 0.56$$

$$distance ( PC , LI ) = 0.48$$

$$10. distance ( PC , LI ) = {w}_{M} * {distance}_{{material}_{family}} + {w}_{F} * {distance}_{fineness} + {w}_{L} * {distance}_{length}$$

$$11. {distance}_{{material}_{family}} = 0.6$$

$$12. {ratio}_{{fineness}_{real}} = \frac{1.5}{1.6} ∉ [ {ratio}_{{ideal}_{min}} = 1 , {ratio}_{{ideal}_{max}} = 1 ]$$

$$13. {expecte}_{fineness} = \frac{1.5}{1} = 1.5$$

$$14. {distance}_{fineness} = \frac{\vert 1.6 - 1.5 \vert}{max ( 1.6 , 1.5 )} = 0.062$$

$$15. {ratio}_{{length}_{real}} = \frac{38}{40} ∉ [ {ratio}_{{ideal}_{min}} = 1 , {ratio}_{{ideal}_{max}} = 1 ]$$

$$16. {expected}_{length} = \frac{38}{1} = 38$$

$$17. {distance}_{length} = \frac{\vert 40 - 38 \vert}{{max}_{length}} = 0.24$$

$$18. distance ( PC , LI ) = 0.75 * 0.6 + 0.175 * 0.062 + 0.075 * 0.24 = 0.48$$

$$distance ( PC , WO ) = 0.63$$

$$1. Distance ( PC , WO ) = \\ 2. {w}_{M} * {distance}_{{material}_{family}} + {w}_{F} * {distance}_{fineness} + {w}_{L} * {distance}_{length}$$

$$3. {distance}_{{material}_{family}} = 0.7$$

$$4. {ratio}_{{fineness}_{real}} = \frac{1.5}{8.85} ∉ [ {ratio}_{{ideal}_{min}} = \frac{1}{22.2} , {ratio}_{{ideal}_{max}} = \frac{1}{14.2} ]$$

$$5. {expecte}_{fineness} = \frac{1.5}{\frac{1}{14.2}} = 21.3$$

$$6. {distance}_{fineness} = \frac{\vert 8.85 - 21.3 \vert}{max ( 8.85 , 21.3 )} = 0.58$$

$$7. {ratio}_{{length}_{real}} = \frac{38}{50} ∈ [ {ratio}_{{ideal}_{min}} = \frac{1}{2} , {ratio}_{{ideal}_{max}} = 1 ]$$

$$8. {distance}_{length} = 0$$

$$9. distance ( PC , WO ) = 0.75 * 0.7 + 0.175 * 0.58 + 0.075 * 0 = 0.63$$

$$distance ( PC , CO - t 2 ) = 0.55$$

$$1. distance ( PC , CO - t 2 ) = {w}_{M} * {distance}_{{material}_{family}} + {w}_{F} * {distance}_{fineness} + {w}_{L} * {distance}_{length}$$

$$2. {distance}_{{material}_{family}} = 0.7$$

$$3. {ratio}_{{fineness}_{real}} = \frac{1.5}{1.5} ∈ [ {ratio}_{{ideal}_{min}} = 1 , {ratio}_{{ideal}_{max}} = 1 ]$$

$$4. {distance}_{fineness} = 0$$

$$5. {ratio}_{{length}_{real}} = \frac{38}{22} ∉ [ {ratio}_{{ideal}_{min}} = 1 , {ratio}_{{ideal}_{max}} = 1 ]$$

$$6. {expected}_{length} = \frac{38}{1} = 38$$

$$7. {distance}_{length} = \frac{\vert 22 - 38 \vert}{{max}_{length}} = 0.32$$

$$8. distance ( PC , CO - t 2 ) = 0.75 * 0.7 + 0.175 * 0 + 0.075 * 0.32 = 0.55$$

$$distance ( PL , CO - t 1 ) = 0.84$$

$$1. distance ( PL , CO - t 1 ) = {w}_{M} * {distance}_{{material}_{family}} + {w}_{F} * {distance}_{fineness} + {w}_{L} * {distance}_{length}$$

$$2. {distance}_{{material}_{family}} = 0.9$$

$$3. {ratio}_{{fineness}_{real}} = \frac{3.3}{1.4} ∉ [ {ratio}_{{ideal}_{min}} = 1 , {ratio}_{{ideal}_{max}} = 1 ]$$

$$4. {expecte}_{fineness} = \frac{3.3}{1} = 3.3$$

$$5. {distance}_{fineness} = \frac{\vert 1.4 - 3.3 \vert}{max ( 1.4 , 3.3 )} = 0.58$$

$$6. {ratio}_{{length}_{real}} = \frac{60}{20} ∉ [ {ratio}_{{ideal}_{min}} = 1 , {ratio}_{{ideal}_{max}} = 1 ]$$

$$7. {expected}_{length} = \frac{60}{1} = 60$$

$$8. {distance}_{length} = \frac{\vert 20 - 60 \vert}{{max}_{length}} = 0.8$$

$$9. distance ( PL , CO - t 1 ) = 0.75 * 0.9 + 0.175 * 0.58 + 0.075 * 0.8 = 0.84$$

$$distance ( PL , LI ) = 0.79$$

$$1. distance ( PL , LI ) = {w}_{M} * {distance}_{{material}_{family}} + {w}_{F} * {distance}_{fineness} + {w}_{L} * {distance}_{length}$$

$$2. {distance}_{{material}_{family}} = 0.9$$

$$3. {ratio}_{{fineness}_{real}} = \frac{3.3}{1.6} ∉ [ {ratio}_{{ideal}_{min}} = 1 , {ratio}_{{ideal}_{max}} = 1 ]$$

$$4. {expecte}_{fineness} = \frac{3.3}{1} = 3.3$$

$$5. {distance}_{fineness} = \frac{\vert 1.6 - 3.3 \vert}{max ( 1.6 , 3.3 )} = 0.51$$

$$6. {ratio}_{{length}_{real}} = \frac{60}{40} ∉ [ {ratio}_{{ideal}_{min}} = \frac{1}{1.05} , {ratio}_{{ideal}_{max}} = \frac{1}{1.05} ]$$

$$7. {expected}_{length} = \frac{60}{1} = 60$$

$$8. {distance}_{length} = \frac{\vert 40 - 60 \vert}{{max}_{length}} = 0.4$$

$$9. distance ( PL , LI ) = 0.75 * 0.9 + 0.175 * 0.51 + 0.075 * 0.4 = 0.79$$

$$distance ( PL , WO ) = 0.53$$

$$1. distance ( PL , WO ) = {w}_{M} * {distance}_{{material}_{family}} + {w}_{F} * {distance}_{fineness} + {w}_{L} * {distance}_{length}$$

$$2. {distance}_{{material}_{family}} = 0.5$$

$$3. {ratio}_{{fineness}_{real}} = \frac{3.3}{8.85} ∉ [ {ratio}_{{ideal}_{min}} = \frac{1}{15} , {ratio}_{{ideal}_{max}} = \frac{1}{13.3} ]$$

$$4. {expecte}_{fineness} = \frac{3.3}{\frac{1}{13.3}} = 43.89$$

$$5. {distance}_{fineness} = \frac{\vert 8.85 - 43.89 \vert}{max ( 1.4 , 3.3 )} = 0.8$$

$$6. {ratio}_{{length}_{real}} = \frac{60}{50} ∉ [ {ratio}_{{ideal}_{min}} = \frac{1}{1.31} , {ratio}_{{ideal}_{max}} = \frac{1}{1.05} ]$$

$$7. {expected}_{length} = \frac{60}{1 / 1.05} = 63$$

$$8. {distance}_{length} = \frac{\vert 50 - 63 \vert}{{max}_{length}} = 0.26$$

$$9. distance ( PL , WO ) = 0.75 * 0.5 + 0.175 * 0.8 + 0.075 * 0.26 = 0.53$$

$$distance ( PL , CO - t 2 ) = 0.83$$

$$1. distance ( PL , CO - t 2 ) = {w}_{M} * {distance}_{{material}_{family}} + {w}_{F} * {distance}_{fineness} + {w}_{L} * {distance}_{length}$$

$$2. {distance}_{{material}_{family}} = 0.9$$

$$3. {ratio}_{{fineness}_{real}} = \frac{3.3}{1.5} ∉ [ {ratio}_{{ideal}_{min}} = 1 , {ratio}_{{ideal}_{max}} = 1 ]$$

$$4. {expecte}_{fineness} = \frac{3.3}{1} = 3.3$$

$$5. {distance}_{fineness} = \frac{\vert 1.5 - 3.3 \vert}{max ( 1.5 , 3.3 )} = 0.54$$

$$6. {ratio}_{{length}_{real}} = \frac{60}{22} ∉ [ {ratio}_{{ideal}_{min}} = 1 , {ratio}_{{ideal}_{max}} = 1 ]$$

$$7. {expected}_{length} = \frac{60}{1} = 60$$

$$8. {distance}_{length} = \frac{\vert 22 - 60 \vert}{{max}_{length}} = 0.76$$

$$9. distance ( PL , CO - t 2 ) = 0.75 * 0.9 + 0.175 * 0.54 + 0.075 * 0.76 = 0.83$$

$$distance ( CO - t 1 , CO - t 1 ) = 0$$

$$1. distance ( CO - t 1 , CO - t 1 ) = {w}_{M} * {distance}_{{material}_{family}} + {w}_{F} * {distance}_{fineness} + {w}_{L} * {distance}_{length}$$

$$2. {distance}_{{material}_{family}} = 0$$

$$3. {ratio}_{{fineness}_{real}} = \frac{1.4}{1.4} ∈ [ {ratio}_{{ideal}_{min}} = 1 , {ratio}_{{ideal}_{max}} = 1 ]$$

$$4. {distance}_{fineness} = 0$$

$$5. {ratio}_{{length}_{real}} = \frac{20}{20} ∈ [ {ratio}_{{ideal}_{min}} = 1 , {ratio}_{{ideal}_{max}} = 1 ]$$

$$6. {distance}_{length} = 0$$

$$7. distance ( CO - t 1 , CO - t 1 ) = 0$$

$$distance ( CO - t 1 , LI ) = 0.28$$

$$1. distance ( CO - t 1 , LI ) = {w}_{M} * {distance}_{{material}_{family}} + {w}_{F} * {distance}_{fineness} + {w}_{L} * {distance}_{length}$$

$$2. {distance}_{{material}_{family}} = 0.3$$

$$3. {ratio}_{{fineness}_{real}} = \frac{1.4}{1.6} ∉ [ {ratio}_{{ideal}_{min}} = 1 , {ratio}_{{ideal}_{max}} = 1 ]$$

$$4. {expecte}_{fineness} = \frac{1.4}{1} = 1.4$$

$$5. {distance}_{fineness} = \frac{\vert 1.6 - 1.4 \vert}{max ( 1.6 , 1.4 )} = 0.125$$

$$6. {ratio}_{{length}_{real}} = \frac{20}{40} ∉ [ {ratio}_{{ideal}_{min}} = 1 , {ratio}_{{ideal}_{max}} = 1 ]$$

$$7. {expected}_{length} = \frac{20}{1} = 20$$

$$8. {distance}_{length} = \frac{\vert 40 - 20 \vert}{{max}_{length}} = 0.4$$

$$9. distance ( CO - t 1 , LI ) = 0.75 * 0.3 + 0.175 * 0.125 + 0.075 * 0.4 = 0.28$$

$$distance ( CO - t 1 , WO ) = 0.3$$

$$1. distance ( CO - t 1 , WO ) = {w}_{M} * {distance}_{{material}_{family}} + {w}_{F} * {distance}_{fineness} + {w}_{L} * {distance}_{length}$$

$$2. {distance}_{{material}_{family}} = 0.3$$

$$3. {ratio}_{{fineness}_{real}} = \frac{1.4}{8.85} ∈ [ {ratio}_{{ideal}_{min}} = \frac{1}{7} , {ratio}_{{ideal}_{max}} = \frac{1}{5} ]$$

$$4. {distance}_{fineness} = 0$$

$$5. {ratio}_{{length}_{real}} = \frac{20}{50} ∉ [ {ratio}_{{ideal}_{min}} = \frac{1}{6} , {ratio}_{{ideal}_{max}} = \frac{1}{5} ]$$

$$6. {expected}_{length} = \frac{20}{1 / 5} = 100$$

$$7. {distance}_{length} = \frac{\vert 50 - 100 \vert}{{max}_{length}} = 1$$

$$8. distance ( CO - t 1 , WO ) = 0.75 * 0.3 + 0.175 * 0 + 0.075 * 1 = 0.3$$

$$distance ( CO - t 1 , CO - t 2 ) = 0.14$$

$$1. distance ( CO - t 1 , CO - t 2 ) = {w}_{M} * {distance}_{{material}_{family}} + {w}_{F} * {distance}_{fineness} + {w}_{L} * {distance}_{length}$$

$$2. {distance}_{{material}_{family}} = 0$$

$$3. {ratio}_{{fineness}_{real}} = \frac{1.4}{1.5} ∉ [ {ratio}_{{ideal}_{min}} = 1 , {ratio}_{{ideal}_{max}} = 1 ]$$

$$4. {expecte}_{fineness} = \frac{1.4}{1} = 1.4$$

$$5. {distance}_{fineness} = \frac{\vert 1.5 - 1.4 \vert}{max ( 1.5 , 1.4 )} = 0.067$$

$$6. {ratio}_{{length}_{real}} = \frac{20}{22} ∉ [ {ratio}_{{ideal}_{min}} = 1 , {ratio}_{{ideal}_{max}} = 1 ]$$

$$7. {expected}_{length} = \frac{20}{1} = 20$$

$$8. {distance}_{length} = \frac{\vert 22 - 20 \vert}{{max}_{length}} = 0.04$$

$$9. distance ( CO - t 1 , CO - t 2 ) = 0.75 * 0 + 0.175 * 0.067 + 0.075 * 0.04 = 0.014$$

Finally, the summary of the distance between components is the following:

distance (PC,CO−t1)=0.56

distance (PC,LI)=0.48

distance (PC,WO)=0.63

distance(PC,CO−t2)=0.55

distance(PL,CO−t1)=0.84

distance(PL,LI)=0.79

distance(PL,WO)=0.53

distance(PL,CO−t2)=0.83

distance(CO−t1, CO−t1)=0

distance(CO−t1,LI)=0.28

distance(CO−t2,WO)=0.3

distance(CO−t1, CO−t2)=0.014

2.2 Assessment of the Four Algorithms

2.2.1 First Approach: Algorithm A1 (Min Algorithm)

This algorithm does not take into account the main components. So, it is iteratively selecting the combinations with smaller distance. So, the first step it is to know the distance of all combinations. The following list contains all the combinations ordered by the distance:

distance(CO−t1,CO−t1)=0

distance(CO−t1,CO−t2)=0.014

distance(CO−t1,LI)=0.28

distance(CO−t2,WO)=0.3

distance(PC,LI)=0.48

distance(PL,WO)=0.53

distance (PC,CO−t2)=0.55

distance(PC,CO−t1)=0.56

distance(PC,WO)=0.63

distance(PL,LI)=0.79

distance (PL,CO−t2)=0.83

distance (PL,CO−t1)=0.84

Then, for this algorithm, the order of the combinations is the following:

1. Start:

Yarn 1 [0.6 PC (1.5, 38), 0.3 PL (3.3, 60), 0.1 CO−t1 (1.4,20)]

Yarn 2 [0.5 CO−t1 (1.4,20), 0.25 LI(1.6, 40), 0.15 W (8.85, 50)), 0.1 CO−t2(1.5,22)]

2. (CO−t1, CO−t1) is the combination with minimum distance and minimum percentage min(0.1,0.5)=0.1, then 0.1 CO−t1 is disgarded from the both yarns

Remaining yarns materials to be compared:

Yarn 1 [0.6 PC (1.5, 38), 0.3 PL (3.3, 60)]

Yarn 2 [0.4 CO−t1(1.4,20), 0.25 LI (1.6, 40), 0.15 W (8.85, 50)), 0.1 CO−t2(1.5,22)]

3. (PC, LI) is the combination with minimum distance and min(0.6, 0.25)=0.25 is the minimum percentage. Then 0.25 PC is extracted from yarn 1 and 0.25 Li is extracted from yarn 2.

Remaining yarns materials to be compared:

Yarn 1 [0.35 PC (1.5, 38), 0.3 PL (3.3, 60)]

Yarn 2 [0.4 CO−t1(1.4,20), 0.15 W (8.85, 50)), 0.1 CO−t2(1.5,22)]

4. (PL, WO) is the combination with minimum distance with minimum percentage: 0.15

Remaining yarns materials to be compared:

Yarn 1 [0.35 PC (1.5, 38), 0.15 PL (3.3, 60)]

Yarn 2 [0.4 CO−t1(1.4,20), 0.1 CO−t2(1.5,22)]

5. (PC, CO−t2) is the combination with minimum distance with minimum percentage: 0.1

Remaining yarns materials to be compared:

Yarn 1 [0.25 PC (1.5, 38), 0.15 PL (3.3, 60)]

Yarn 2 [0.4 CO−t1 (1.4,20)]

6. (PC, CO−t1) is the combination with minimum distance with minimum percentage: 0.25

Remaining yarns materials to be compared:

Yarn 1 [0.15 PL (3.3, 60)]

Yarn 2 [0.15 CO−t1 (1.4,20)]

7. PL,CO−t1)) is the combination with minimum distance and the last one, with minimum percentage: 0.15

Remaining yarns materials to be compared:

Yarn 1: [ø]

Yarn 2: [ø]

8. distance(yarn1, yarn2)=0.1*0+0.25*0.48+0.15*0.53+0.1*0.55+0.25*0.56+0.15*0.84=0.52

Representation of how the portions of materials are compared with other portion of materials with the same percentage:

2.2.2 Second Approach: Algorithm A2 (Main Min Algorithm)

The algorithm maps the material of the first yarn with the material of the second yarn. First, the main materials are taken into account and then the rest of materials. The distance between materials is the following:

distance(CO−t1,CO t1)=0

distance(CO−t1,CO−t2)=0.014

distance(CO−t1,LI)=0.28

distance(CO−t2,WO)=0.3

distance(PC,LI)=0.48

distance(PL,WO)=0.53

distance(PC,CO−t2)=0.55

distance(PC,CO−t1)=0.56

distance(PC,WO)=0.63

distance(PL,LI)=0.79

distance(PL,CO−t2)=0.83

distance(PL,CO−t1)=0.84

1. We take the main materials (0.6 PC, 0.5 CO−t1), then we use the min percentage (0.5). Notice that in this example there is only 1 combination of main materials.
1. main1=max_component(yarn 1)=0.6 PC
2. main2=max_component(yarn 2)=0.5 CO−t1
3. p=min_percentages (main1, main2)=0.5
4. The main combination is: 0.5 (PC,CO−t1)

2. Now, we have (without mains):

Yarn 1 [0.1PC (1.5,38),0.3 PL (3.3, 60), 0.1 CO−t1(1.4,20)]

Yarn 2 [0.25 LI (1.6, 40), 0.15 W (8.85, 50),0.1 CO−t2(1.5,22)]

3. Select between combinations depending on the distance, as in the first algorithm:
a. 0.1 (CO−t1,CO−t2) is the combination with minimum distance and the last one.
Remaining yarns materials to be compared:
Yarn 1 [0.1PC (1.5,38),0.3 PL (3.3, 60)]
Yarn 2 [0.25 LI (1.6, 40), 0.15 W (8.85, 50)]
b. 0.1 (PC,LI) is the combination with minimum distance and the last one.
Remaining yarns materials to be compared:
Yarn 1 [0.3 PL (3.3, 60)]
Yarn 2 [0.15 LI (1.6, 40), 0.15 W (8.85, 50)]
c. 0.15 (PL,WO) is the combination with minimum distance and the last one.
Remaining yarns materials to be compared:
Yarn 1 [0.15 PL (3.3, 60)]
Yarn 2 [0.15 LI (1.6, 40)]
d. 0.15 (PL, LI) is the combination with minimum distance and the last one.
Remaining yarns materials to be compared:
Yarn1: [ø]
Yarn 2: [ø]

4. Distance (yarn₁, yarn₂)=0.5*0.56+0.1*0.014+0.1*0.48+0.15*0.53+0.15*0.79=0.53

Representation of how the portions of materials are compared with other portion of materials with the same percentage but selecting first the main portions (50% PC and 50% CO−t1)

2.2.3 Third Approach: Algorithm A3 (Cross Algorithm)

This algorithm does not take into account the main materials. First, the common part (distance=0) are removed and the all the possible combinations are compared.

Using the distance between the materials assessed in previous algorithms, we have:

distance(CO−t1,CO−t1)=0

distance(CO−t1,CO−t2)=0.014

distance(CO−t1,LI)=0.28

distance(CO−t2,WO)=0.3

distance(PC,LI)=0.48

distance(PL,WO)=0.53

distance(PC,CO−t2)=0.55

distance(PC,CO−t1)=0.56

distance(PC,WO)=0.63

distance(PL,LI)=0.79

distance(PL,CO−t2)=0.83

distance(PL,CO−t1)=0.84

1. Removing common part from:

Yarn 1 [0.6 PC (1.5, 38), 0.3 PL (3.3, 60), 0.1 CO−t1(1.4,20)]

Yarn 2 [0.5 CO−t1(1.4,20), 0.25 LI (1.6, 40), 0.15 W (8.85, 50)), 0.1 CO−t2(1.5,22)]

Common part=0.1 (CO−t1, CO−t1)

2. The common part is extracted and the rest is:

Yarn 1 [0.6 PC (1.5, 38), 0.3 PL (3.3, 60)]

Yarn 2 [0.4 CO−t1(1.4,20), 0.25 LI (1.6, 40), 0.15 W (8.85, 50)), 0.1 CO−t2(1.5,22)]

3. Then the distance of comparing all the combinations is:

$$4. distance ( yarn 1 , yarn 2 ) = \frac{[ \begin{matrix}\begin{matrix}0.6 * 0.4 * d ( PC , CO - t 1 ) + 0.6 * 0.25 * d ( PC , LI ) + \\ 0.6 * 0.15 * d ( PC , WO ) + 0.6 * 0.1 * d ( PC , CO - t 2 ) +\end{matrix} \\ \begin{matrix}0.3 * 0.4 * d ( PL , CO - t 1 ) + 0.3 * 0.25 * d ( PL , LI ) + \\ 0.3 * 0.15 * d ( PL , WO ) + 0.3 * 0.1 * d ( PL , CO - t 2 )\end{matrix}\end{matrix} ]}{0.6 + 0.3}$$

$$\frac{[ \begin{matrix}0.6 * 0.4 * 0.56 + 0.6 * 0.25 * 0.48 + \\ 0.6 * 0.15 * 0.63 + 0.6 * 0.1 * 0.55 + \\ 0.3 * 0.4 * 0.84 + 0.3 * 0.25 * 0.79 + \\ 0.3 * 0.15 * 0.63 + 0.3 * 0.1 * 0.83\end{matrix} ]}{0.9} = 0.5 .66$$

Representation of how the portions of materials that are not common to both yarns are compared all against all.

2.2.4 Fourth Approach: Algorithm A4 (MainHigher Algorithm)

This algorithm selects the combinations in base to the percentages.

Using the distance between the materials assessed in previous algorithms, we have:

distance(CO−t1,CO−t1)=0

distance(CO−t1,CO−t2)=0.014

distance(CO−t1,LI)=0.28

distance(CO−t2,WO)=0.3

distance(PC,LI)=0.48

distance(PL,WO)=0.53

distance(PC,CO−t2)=0.55

distance(PC,CO−t1)=0.56

distance(PC,WO)=0.63

distance(PL,LI)=0.79

distance(PL,CO−t2)=0.83

distance(PL,CO−t1)=0.84

Notice that in this case there is only one combination of main materials and the number of materials in both yarns is the same. Therefore, the resulting algorithm is:

1. Start:

Yarn 1 [0.6 PC (1.5, 38), 0.3 PL (3.3, 60), 0.1 CO−t1(1.4,20)]

Yarn 2 [0.5 CO−t1(1.4,20), 0.25 LI (1.6, 40), 0.15 W (8.85, 50)), 0.1 CO−t2(1.5,22)]

2. We select the main component: 0.6 PC 0.5 CO−t1

3. We select the materials depending on the higher percentage, therefore are:
a. 0.3PL, 0.25 LI
b. 0.1 CO−t1,0.15 WO
c. −, 0.1 CO−t2

4. distance(yarn1,yarn2)=mean(0.6,0.5)*d(PC,CO−t1)+mean (0.3,0.25)* d(PL, LI)+mean(0.1,0.15)*d(CO−t1,WO)+0.1/2*dif fₘₐₓ=

5. 0.55*0.56+0.275*0.79+0.125*0.3+0.05*1=0.613

Representation of how materials are compared with other materials depending on the percentage of presence is shown. One proceeds from more percentage to less. In this example where the number of materials is different, it is shown that the last material of yarn 2 it is not compared with a material but it count as a maximum distance.

2.3 Final Result

The result is the average of four algorithms:

Final Distance=mean(0.52,0.53,0.566,0.613)=0.56

3. Material family codes

This is the used list, but this list could be shorter or longer, more specific or more general
WO: Wool
COR: Regenerated Cotton
CO: Cotton
PC: Acrylic
AR: Aramid
LI: Flax/Linen
PA: Polyamide/Nylon
PP: Polypropylene
PL: Polyester
SE: Silk
VI: Viscose
XX: Rest of families

1. Computer implemented method for dissimilarity computation between two yarns to be used for setting of a textile machine in a textile process for manufacturing a textile product, wherein in the textile process a first yarn is used and said setting involving the use of at least a second yarn selected from several candidate yarns, both said first and said at least second yarns being identified by physical properties including at least count and by a list of materials, each material in turn being defined by percentage of presence, belonging to a family of materials and by some physical material properties including finesses and length, comprising:
a) automatically computing material dissimilarity values of all possible combination of the materials of said list of materials of the first and second yarns; and
b) automatically calculating a dissimilarity value between the first and second yarns by applying an algorithm using as inputs the list of materials of the first and second yarns and said computed material dissimilarity values, applying of said algorithm including a weighted aggregation using said material dissimilarity values computed of different combination of pairs of materials of said first and second yarns, where the weights depend on the presence and/or percentage of these materials in the yarns.

2. A computer implemented method according to claim 1 wherein said first and second yarns are different in that having a different percentage of the same materials and/or in that they include a list of different materials and/or in having a different value for some material properties.

3. A computer implemented method according to claim 1, wherein said computing of material dissimilarity values uses a textile expert knowledge that provides at least dissimilarity between each pair of materials.

4. A computer implemented method according to claim 3, wherein said textile expert knowledge further provides an optimal range of length and optimal range of fineness between each pair of materials.

5. A computer implemented method according to claim 4, wherein said algorithm performs comparisons among pairs of materials of said first and second yarns with an equivalent percentage in common and proceeds iteratively selecting the combinations of the pairs to be compared having a lower dissimilarity value being the corresponding weight for each pair of materials the smallest percentage and then comparing among them the rest of materials, obtaining several material dissimilarity values and then performing a weighted aggregation of said dissimilarity values.

6. A computer implemented method according to claim 4, wherein said algorithm performs comparisons among pairs of materials of said first and second yarns taking into account the main material with an equivalent percentage and proceeds iteratively selecting the combinations of the pairs to be compared having a lower dissimilarity value being the corresponding weight for each pair of materials the smallest percentage and then comparing among them the rest of materials, obtaining several material dissimilarity values and then performing a weighted aggregation of said dissimilarity values.

7. A computer implemented method according to claim 4 wherein said algorithm disregards first a common part from both first and second yarns involving a set of pairs of materials with an equivalent percentage and dissimilarity equal to 0, and if the percentages are not equal, then only the lower percentage is disregarded and then all the possible combinations among the pairs of the list of the remaining materials of both yarns are compared obtaining several material dissimilarity values and then performing a weighted aggregation of the material dissimilarity values wherein the weight for each pair of materials is the product of both material percentages divided by the percentage of the remaining uncommon part.

8. A computer implemented method according to claim 4 wherein said algorithm performs an iterative comparison selecting the possible combinations among the list of pairs of materials of said first and second yarns by percentage operating by decreasing order of percentage obtaining several material dissimilarity values and then performing a weighted aggregation of said dissimilarity values and in case the number of materials in a list being not the same, each material in a list without pair a maximum dissimilarity value equal to 1 is added to said aggregation, wherein each material dissimilarity weight is computed as the mean value of both percentages of each pair of materials.

9. A computer implemented method according to claim 2, wherein said algorithm is an average or a combination of two or more of the following algorithms a11 to a14:
a11: performing comparisons among pairs of materials of said first and second yarns with an equivalent percentage in common and proceeds iteratively selecting the combinations of the pairs to be compared having a lower dissimilarity value being the corresponding weight for each pair of materials the smallest percentage and then comparing among them the rest of materials, obtaining several material dissimilarity values and then performing a weighted aggregation of said dissimilarity values;
a12: performing comparisons among pairs of materials of said first and second yarns taking into account the main material with an equivalent percentage and proceeds iteratively selecting the combinations of the pairs to be compared having a lower dissimilarity value being the corresponding weight for each pair of materials the smallest percentage and then comparing among them the rest of materials, obtaining several material dissimilarity values and then performing a weighted aggregation of said dissimilarity values;
a13: disregarding first a common part from both first and second yarns involving a set of pairs of materials with an equivalent percentage and dissimilarity equal to 0, and if the percentages are not equal, then only the lower percentage is disregarded and then all the possible combinations among the pairs of the list of the remaining materials of both yarns are compared obtaining several material dissimilarity values and then performing a weighted aggregation of the material dissimilarity values wherein the weight for each pair of materials is the product of both material percentages divided by the percentage of the remaining uncommon part; and
a14: performing an iterative comparison selecting the possible combinations among the list of pairs of materials of said first and second yarns by percentage operating by decreasing order of percentage obtaining several material dissimilarity values and then performing a weighted aggregation of said dissimilarity values and in case the number of materials in a list being not the same, each material in a list without pair a maximum dissimilarity value equal to 1 is added to said aggregation, wherein each material dissimilarity weight is computed as the mean value of both percentages of each pair of materials.

10. A computer implemented method according to claim 9, wherein a result useful for setting of a textile machine using said at least second yarn is computed from a weighted aggregation of a dissimilarity value obtained from a method according to an average or a combination of two or more of said algorithms of claim 9 and other dissimilarities values regarding physical properties of said at least second yarn including at least count of the involved yarns obtained from a textile expert knowledge.

11. A computer implemented method according to claim 1, wherein said other dissimilarities values also comprise sector, as a non-physical property of the involved yarns to be considered in the weighted aggregation.

12. A computer implemented method according to claim 1, wherein said computed material dissimilarity values of all possible combination of the materials, of said list of materials of the first and second yarns, are comprised between 0 and 1.

13. A computer program product comprising instructions that when executed in a processor performs a method according to claim 1.

14. The computer program product according to claim 13 wherein said instructions when executed in a processor further performs a method wherein the algorithm is an average or a combination of two or more of the following algorithms a11 to a14:
a11: performing comparisons among pairs of materials of said first and second yarns with an equivalent percentage in common and proceeds iteratively selecting the combinations of the pairs to be compared having a lower dissimilarity value being the corresponding weight for each pair of materials the smallest percentage and then comparing among them the rest of materials, obtaining several material dissimilarity values and then performing a weighted aggregation of said dissimilarity values;
a12: performing comparisons among pairs of materials of said first and second yarns taking into account the main material with an equivalent percentage and proceeds iteratively selecting the combinations of the pairs to be compared having a lower dissimilarity value being the corresponding weight for each pair of materials the smallest percentage and then comparing among them the rest of materials, obtaining several material dissimilarity values and then performing a weighted aggregation of said dissimilarity values;
a13: disregarding first a common part from both first and second yarns involving a set of pairs of materials with an equivalent percentage and dissimilarity equal to 0, and if the percentages are not equal, then only the lower percentage is disregarded and then all the possible combinations among the pairs of the list of the remaining materials of both yarns are compared obtaining several material dissimilarity values and then performing a weighted aggregation of the material dissimilarity values wherein the weight for each pair of materials is the product of both material percentages divided by the percentage of the remaining uncommon part; and
a14: performing an iterative comparison selecting the possible combinations among the list of pairs of materials of said first and second yarns by percentage operating by decreasing order of percentage obtaining several material dissimilarity values and then performing a weighted aggregation of said dissimilarity values and in case the number of materials in a list being not the same, each material in a list without pair a maximum dissimilarity value equal to 1 is added to said aggregation, wherein each material dissimilarity weight is computed as the mean value of both percentages of each pair of materials.

15. The computer program product according to claim 14, wherein a result useful for setting of a textile machine using said at least second yarn is computed from a weighted aggregation of a dissimilarity value obtained from a method according to an average or a combination of two or more of said algorithms all -a14 and other dissimilarities values regarding physical properties of said at least second yarn including at least count of the involved yarns obtained from a textile expert knowledge.

16. The computer program product according to claim 13 wherein said other dissimilarities values also comprise sector, as a non-physical property of the involved yarns to be considered in the weighted aggregation.
